(19) United States
(12) Patent Application Publication
(10) Pub. No.: US 2008/0155401 A1
(43) Pub. Date: Jun. 26, 2008

(54) REPRODUCING APPARATUS AND FILE INFORMATION DISPLAY METHOD

(75) Inventor: Hirofumi Honda, Machida-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/959,202

(22) Filed: Dec. 18, 2007

(30) Foreign Application Priority Data
Dec. 20, 2006 (JP) 2006-342971

(51) Int. Cl. G06F 3/14

(52) U.S. Cl. 715/273

(57) ABSTRACT

A reproducing apparatus includes a reproduction unit configured to reproduce a file recorded on a storage medium, a transfer unit configured to transfer a file recorded on the storage medium to an external device, an external device connection detection unit configured to detect a connection with the external device, and a display processing unit configured to display file information about the file in a first display style if a connection with the external device is detected by the external device connection detection unit and to display file information about the file in a second display style if a connection with the external device is not detected by the external device connection detection unit.

### BACKGROUND OF THE INVENTION

1. Field of the Invention

The present invention relates to a reproducing apparatus and a file information display method.

2. Description of the Related Art

In recent years, along with increasing capacities of randomly accessible storage media, such as memory cards, digital versatile discs (DVDs), and hard disk drives (HDDs), these storage media are now widely used as recording media to store image data. A distinctive feature of these randomly accessible storage media is to provide a user easy access to image files.

Taking advantage of the accessibility to image files, display methods for listing and displaying files stored in recording media and searching for a target file have been widely employed. Further, techniques for improving the operability of these methods have been proposed.

For example, Japanese Patent Application Laid-Open No. 10-124353 discusses a method in which, in listing and displaying representative images and content information of image files stored in a recording medium, a user can set optional information, such as title information, in addition to information on shooting date and time, a file capacity, or the like, which is significant for searching.

As discussed in Japanese Patent Application Laid-Open No. 10-124353, to search image files stored in a recording medium, it is important to display the optimum content information for searching. However, the optimum content information for searching varies depending on purposes of the searching. For example, if a user wishes to search for a file to be reproduced, information about shooting title and shooting date is significant. If a user wishes to search for a file to be transferred, information about transfer time and file capacity is significant.

In order to address these various searching purposes, it is required to display a larger number of content information (file information). However, on the other hand, in displaying a list of files, it is important to display a larger number of files on a screen for viewing. Thus, a volume of information that can be displayed on one screen may be limited.

### SUMMARY OF THE INVENTION

The present invention is directed to a reproducing apparatus that can display file information suitable for purposes.

According to an aspect of the present invention, a reproducing apparatus includes a reproduction unit configured to reproduce a file recorded on a storage medium, a transfer unit configured to transfer a file recorded on the storage medium to an external device, an external device connection detection unit configured to detect a connection with the external device, and a display processing unit configured to display file information about the file in a first display style if a connection with the external device is detected by the external device connection detection unit and to display file information about the file in a second display style if a connection with the external device is not detected by the external device connection detection unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating essential parts in a hardware configuration of a reproducing apparatus according to a first exemplary embodiment of the present invention.

FIG. 2 is a flowchart illustrating an exemplary display process performed by a display processing unit according to the first exemplary embodiment of the present invention.

FIGS. 3A and 3B are views illustrating exemplary displays according to the first exemplary embodiment of the present invention.

FIG. 4 is a block diagram illustrating essential parts in a hardware configuration of a reproducing apparatus according to a second exemplary embodiment of the present invention.

FIG. 5 is a flowchart illustrating an exemplary display process performed by a display processing unit according to the second exemplary embodiment of the present invention.

FIG. 6 is a block diagram illustrating essential parts in a hardware configuration of a reproducing apparatus according to a third exemplary embodiment of the present invention.

FIG. 7 is a flowchart illustrating an exemplary display process performed by a display processing unit according to the third exemplary embodiment of the present invention.

FIGS. 8A to 8C are views illustrating exemplary displays according to the third exemplary embodiment of the present invention.

FIG. 9 is a flowchart illustrating an exemplary display process performed by a display processing unit according to the third exemplary embodiment of the present invention.

FIG. 10 is a block diagram illustrating essential parts in a hardware configuration of a reproducing apparatus according to a fourth exemplary embodiment of the present invention.

FIG. 11 is a flowchart illustrating an exemplary display process performed by a display processing unit according to the fourth exemplary embodiment of the present invention.

FIGS. 12A to 12C are views illustrating exemplary displays according to the fourth exemplary embodiment of the present invention.

FIG. 13 is a flowchart illustrating an exemplary display process performed by a display processing unit according to the fourth exemplary embodiment of the present invention.

FIG. 14 is a block diagram illustrating essential parts in a hardware configuration of a reproducing apparatus according to a fifth exemplary embodiment of the present invention.

FIG. 15 is a flowchart illustrating an exemplary display process performed by a display processing unit according to the fifth exemplary embodiment of the present invention.

FIG. 16 is a flowchart illustrating another exemplary display process performed by a display processing unit according to the fifth exemplary embodiment of the present invention.

### DETAILED DESCRIPTION OF THE EMBODIMENTS

Various exemplary embodiments, features, and aspects of the invention will be described in detail below with reference to the drawings.

### First Exemplary Embodiment

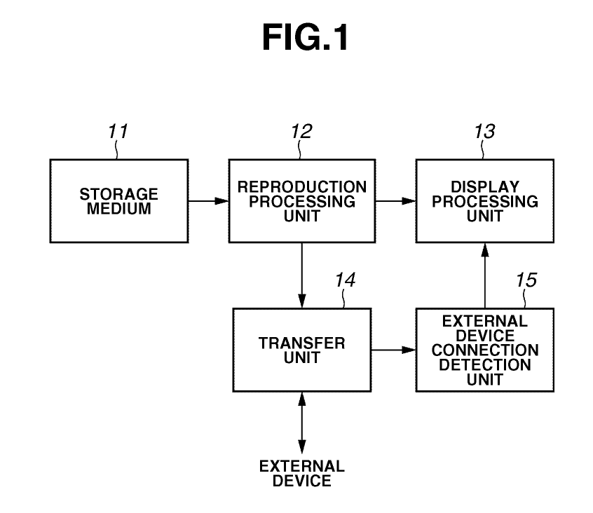

FIG. 1 is a block diagram illustrating essential parts in a hardware configuration of a reproducing apparatus according to a first exemplary embodiment of the present invention. In FIG. 1, a storage medium 11 stores image files. A reproduction processing unit (reproduction control unit) 12 reproduces an image file stored in the storage medium 11. A display processing unit (display control unit) 13 displays a list of images and content information (file information) using image files reproduced by the reproduction processing unit 12. A transfer unit 14 transfers an image file reproduced by the reproduction processing unit 12 to an external device. An external device connection detection unit 15 detects a connection status between the transfer unit 14 (or the reproducing apparatus) and an external device.

The display processing unit 13, depending on a connection status with an external device, generates content information that includes information required in each connection status and displays the content information. More specifically, if a connection with an external device is detected, the display processing unit 13 displays a list that shows display information that includes “content information including information necessary for file transfer” (display style 1 or first display style). If a connection with an external device is not detected, the display processing unit 13 displays a list that shows display information that includes “content information including information necessary for file search” (display style 2 or second display style).

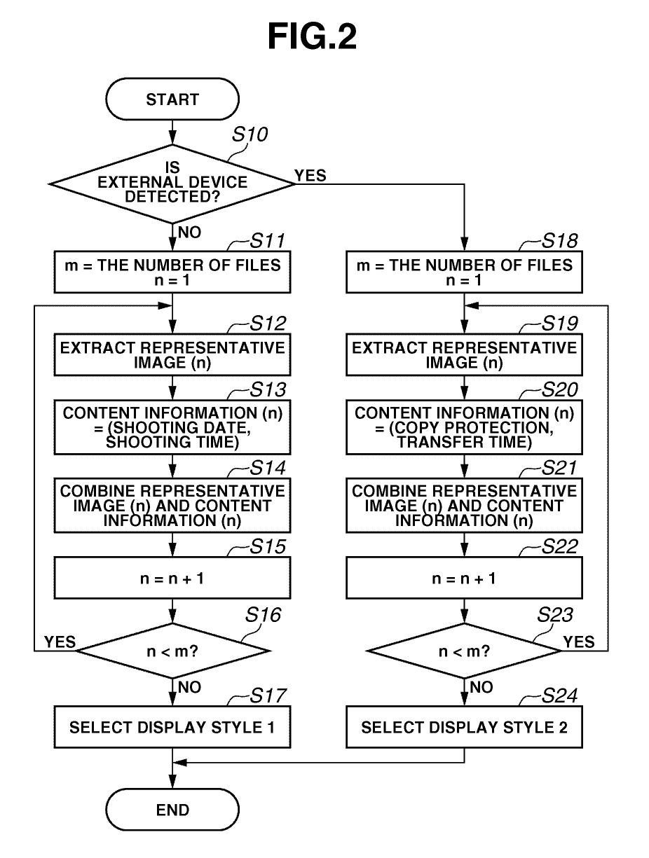

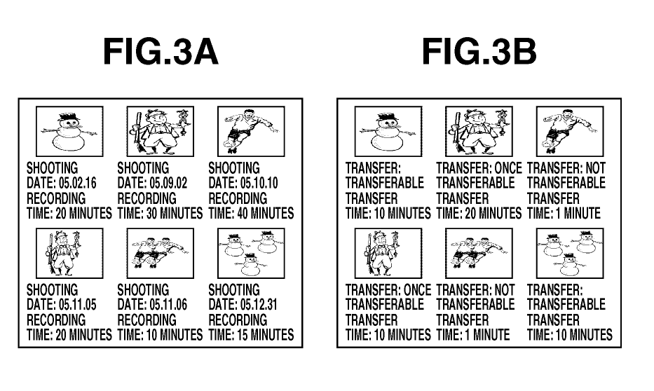

Now, operations performed by the display processing unit 13 are described with reference to a flowchart illustrated in FIG. 2 and exemplary displays illustrated in FIGS. 3A and 3B.

FIG. 2 is a flowchart illustrating an exemplary display process performed by the display processing unit 13. FIGS. 3A and 3B are views illustrating exemplary displays.

In step S10, the display processing unit 13 determines whether an external device is detected based on detection information from the external device connection detection unit 15. If the display processing unit 13 determines that connection with an external device is not detected (NO in step S10), the process proceeds to step S11.

In step S11, the display processing unit 13 sets the total number of files reproduced by the reproduction processing unit 12 to a variable m, sets “1” to a variable n to initialize the variables, and starts generation of information about a list to be displayed. The display information for each image file is generated in three processing steps that include extraction of a representative image in step S12, extraction of content information in step S13, and combination of the representative image and the content information in step S14. It is noted that shooting dates and recording times are set as the content information in the present embodiment. However, high-compression/high-definition compression rate information, high-definition/standard-definition (HD/SD) recording format information, and other information stored in image files, for example, can be set as the content information. The variable n denotes an image file that is reproduced at n-th time.

When display information for one image file is completely generated, the display processing unit 13 increments the variable n in step S15. In step S16, the display processing unit 13 determines whether the variable n has reached the total number of files m. If it is determined that the variable n has not yet reached the total number of files m (YES in step S16), the process returns to step S12. Then, the display processing unit 13 repeatedly performs processing from step S12 to step S15.

In step S16, if it is determined that the variable n has reached the total number of files m (NO in step S16), the display processing unit 13 finishes the generation process for the display information. In step S17, the display processing unit 13 displays a list of the generated display information in a display style 1 illustrated in FIG. 3A, which is suitable for file search. In FIG. 3A, shooting dates (shooting date information) and recording times (recording time information) are displayed as the display information together with representative images.

On the other hand, if it is determined that an external device is detected in step S10 (YES in step S10), the process proceeds to step S18. In step S18, the display processing unit 13 sets the total number of files reproduced by the reproduction processing unit 12 to the variable m and sets “1” to the variable n to initialize the variables, and starts generation of display information for list display. The display information for each image file is generated in three processing steps that include extraction of a representative image in step S19, extraction of content information in step S20, and combination of the representative image and the content information in step S21. It is noted that copy protection information and setting of transfer times are set as the content information in the present embodiment. However, high-compression/high-definition compression rate information, HD/SD recording format information, and other information necessary for file transfer, for example, can be set as the content information. The variable n denotes an image file that is reproduced at n-th time.

In response to completion of the generation of the display information with respect to one image file, the display processing unit 13 increments the variable n in step S22. In step S23, the display processing unit 13 determines whether the variable n has reached the total number of files m. If it is determined that the variable n has not yet reached the total number of files m (YES in step S23), the process returns to step S19. Then, the display processing unit 13 repeatedly performs processing from step S19 to step S22.

In step S23, if it is determined that the variable n has reached the total number of files m (NO in step S23), the display processing unit 13 finishes the generation process of the display information. In step S24, the display processing unit 13 displays a list of the generated display information in a display style 2 illustrated in FIG. 3B, which is suitable for file transfer. In FIG. 3B, information as to whether transfer is allowable, and, if transfer is allowable, the allowable number of times of transfer and transfer time information are displayed as the display information together with representative images.

FIGS. 3A and 3B each illustrate an example of displaying a list of six image files. However, the present exemplary embodiment is not limited to the illustrated examples. For example, the number of displayed image files can be one. Moreover, image files can be displayed over a plurality of pages. These can also be applied to the following exemplary embodiments.

As described above, according to the first exemplary embodiment, depending on whether the connection with an external device is detected, file information can be displayed in an appropriate display style as illustrated in FIGS. 3A and 3B. Thus, file information adapted for purposes can be displayed.

### Second Exemplary Embodiment

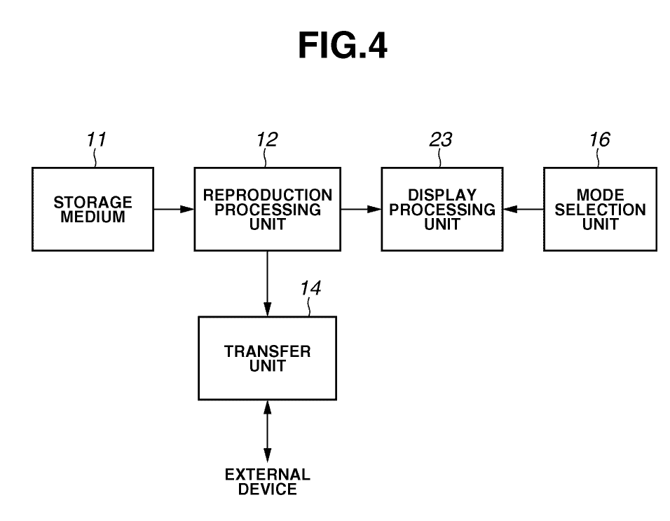

FIG. 4 is a block diagram illustrating essential parts in a hardware configuration of a reproducing apparatus according to a second exemplary embodiment of the present invention. In the reproducing apparatus illustrated in FIG. 4, the external device connection detection unit 15 according to the first exemplary embodiment is not included as a constituent element. However, a mode selection unit 16 is included as a constituent element instead of the external device connection detection unit 15. The mode selection unit 16, for example, selects a “file search/reproduction mode” or a “file transfer mode” based on an operation instruction from a user.

Further, the reproducing apparatus illustrated in FIG. 4 includes, in place of the display processing unit 13 according to the first exemplary embodiment, a display processing unit 23 that performs control (or process) different from that performed by the display processing unit 13, as a constituent element.

The display processing unit 23, depending on a selective status of the file transfer mode, generates content information that includes information required in each status and displays the content information. More specifically, if the file transfer mode is selected, the display processing unit 23 displays a list that shows display information that includes “content information including information necessary for file transfer” in a display style 1. If a mode other than the file transfer mode is selected, the display processing unit 23 displays a list that shows display information that includes “content information including information necessary for file search” in a display style 2.

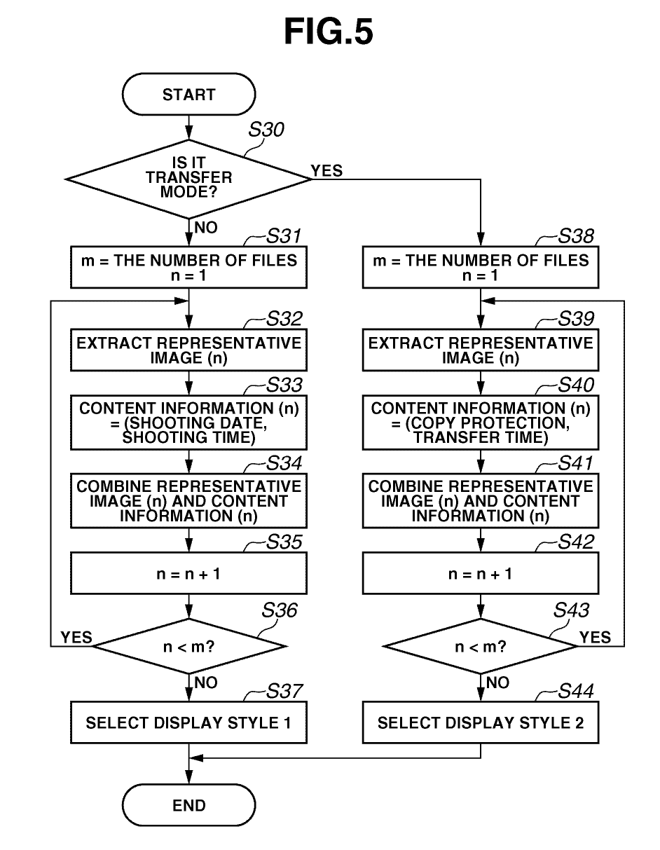

Now, operation performed by the display processing unit 23 is described with reference to a flowchart illustrated in FIG. 5 and exemplary displays illustrated in FIGS. 3A and 3B. FIG. 5 is a flowchart illustrating an exemplary display process performed by the display processing unit 23.

In step S30, the display processing unit 23 determines whether the file transfer mode is selected by the mode selection unit 16. If the display processing unit 23 determines that a mode other than the file transfer mode is selected (NO in step S30), the process proceeds to step S31.

In step S31, the display processing unit 23 sets the total number of files reproduced by the reproduction processing unit 12 to a variable m, sets “1” to a variable n to initialize the variables, and starts generation of information about a list to be displayed. The display information for each image file is generated in three processing steps that include extraction of a representative image in step S32, extraction of content information in step S33, and combination of the representative image and the content information in step S34. It is noted that shooting dates and recording times are set as the content information in the present embodiment. However, high-compression/high-definition compression rate information, HD/SD recording format information, and other information stored in image files, for example, can be set as the content information. The variable n denotes an image file that is reproduced at n-th time.

In response to completion of the generation of the display information with respect to one image file, the display processing unit 23 increments the variable n in step S35. In step S36, the display processing unit 23 determines whether the variable n has reached the total number of files m. If it is determined that the variable n has not yet reached the total number of files m (YES in step S36), the process returns to step S32. Then, the display processing unit 23 repeatedly performs processing from step S32 to step S35.

In step S36, if it is determined that the variable n has reached the total number of files m (NO in step S36), the display processing unit 23 finishes the generation process of the display information. In step S37, the display processing unit 23 displays a list of the generated display information in the display style 1 adapted for file search, as illustrated in FIG. 3A.

On the other hand, if it is determined that the file transfer mode is selected (YES in step S30), the process proceeds to step S38. In step S38, the display processing unit 23 sets the total number of files reproduced by the reproduction processing unit 12 to the variable m, sets “1” to the variable n to initialize the variables, and starts generation of information about a list to be displayed. The display information for each image file is generated in three processing steps that include extraction of a representative image in step S39, extraction of content information in step S40, and combination of the representative image and the content information in step S41. It is noted that copy protection information and setting of transfer times are set as the content information in the present embodiment. However, high-compression/high-definition compression rate information, HD/SD recording format information, and other information necessary for file transfer, for example, can be set as the content information. The variable n denotes an image file that is reproduced at n-th time.

When the display information for one image file is completely generated, the display processing unit 23 increments the variable n in step S42. In step S43, the display processing unit 23 determines whether the variable n has reached the total number of files m. If it is determined that the variable n has not yet reached the total number of files m (YES in step S43), the process returns to step S39. Then, the display processing unit 23 repeatedly performs processing from step S39 to step S42

In step S43, if it is determined that the variable n has reached the total number of files m (NO in step S43), the display processing unit 23 finishes the generation process of the display information. In step S44, the display processing unit 23 displays a list of the generated display information in the display style 2 adapted for file transfer, as illustrated in FIG. 3B.

As described above, according to the second exemplary embodiment, according to the transfer mode, the file information can be displayed in an appropriate display style as illustrated in FIGS. 3A and 3B. Thus, file information adapted for purposes can be displayed.

### Third Exemplary Embodiment

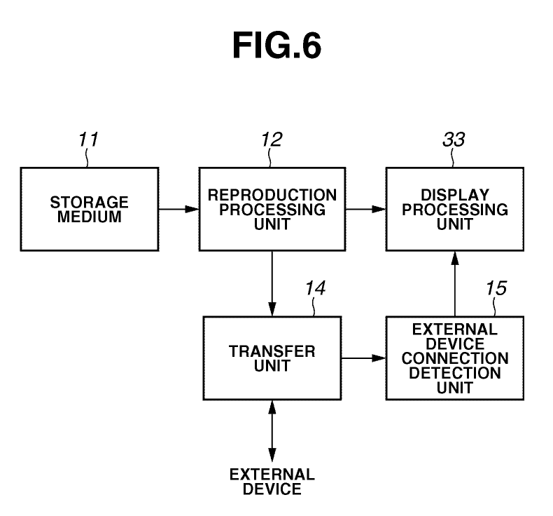

FIG. 6 is a block diagram illustrating essential parts in a hardware configuration of a reproducing apparatus according to a third exemplary embodiment of the present invention. The reproducing apparatus illustrated in FIG. 6 includes, in place of the display processing unit 13 according to the first exemplary embodiment, a display processing unit 33 that performs control (or process) different from that performed by the display processing unit 13, as a constituent element.

The display processing unit 33 performs the process that “depending on whether a file is a copy-inhibited file, changes the display” in addition to the process that “depending on a status of connection with an external device, generates content information that includes information required in each status and displays the content information” described in the first exemplary embodiment.

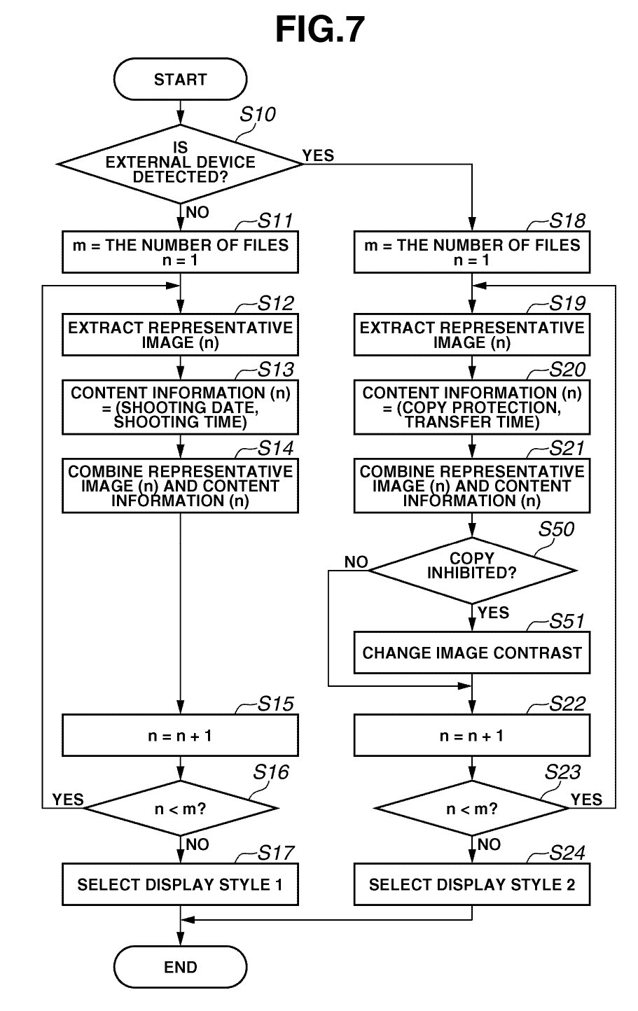

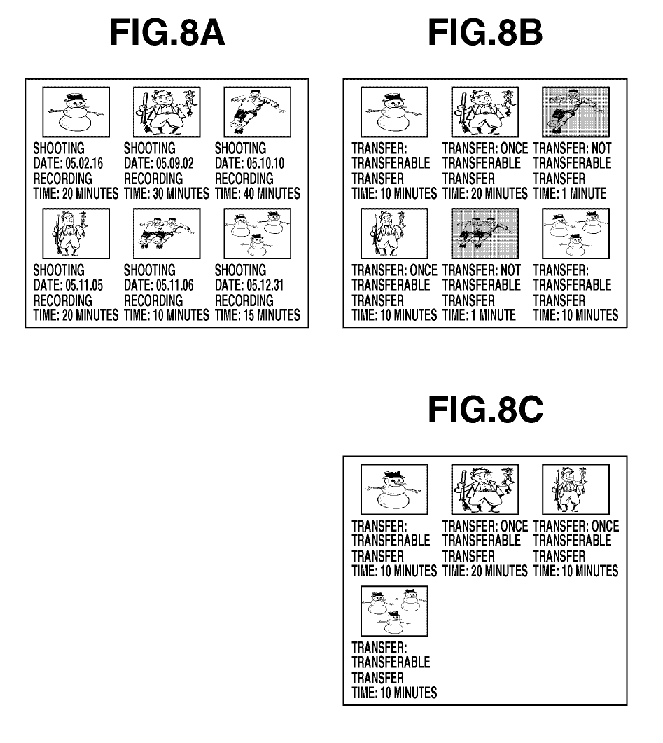

Now, operation of the display processing unit 33 will be described with reference to a flowchart illustrated in FIG. 7 and exemplary displays illustrated in FIGS. 8A to 8C. FIG. 7 is a flowchart illustrating an exemplary display process performed by the display processing unit 33. FIGS. 8A to 8C are views illustrating exemplary displays.

In FIG. 7, the same reference numbers as those in FIG. 2 are applied to steps in which a similar process to that in FIG. 2 according to the first exemplary embodiment is performed, and their descriptions are not repeated unless otherwise noted. Moreover, a display style illustrated in FIG. 8A is similar to that illustrated in FIG. 3A.

Subsequent to step S21, the process proceeds to step S50. In step S50, the display processing unit 33 determines whether content (file) is copy-inhibited, in other words, transferable, based on copy protection information set as the content information in step S20. If the display processing unit 33 determines that the contents is not copy-inhibited (i.e., transferable) (NO in step S50), the process skips step S51 and proceeds to step S22. On the other hand, if the display processing unit 33 determines that the contents is copy-inhibited (i.e., not transferable) (YES in step S50), the process proceeds to step S51. In step S51, the display processing unit 33 changes an image contrast, for example, by decreasing the image contrast. It is noted that the process in step S51 is not limited to the change of the image contrast as long as the image can be differentiated from the other images.

In step S24 illustrated in FIG. 7, the display processing unit 33 displays a list in a display style 2 illustrated in FIG. 8B, which is adapted for file transfer.

With the process illustrated in FIG. 7, the display processing unit 33 can change the image contrast of a file that is not transferable to an external device, as illustrated in FIG. 8B, and can display the file information. Thus, file information adapted for purposes can be displayed in an easily recognizable way, and search performance for files to be transferred can be improved.

It is noted that the process of “image contrast change” in step S51 in FIG. 7 can be changed to the process of “representative image and content information deletion”. In such a case, the list displayed in step S24 in FIG. 7 is displayed in a display style 2 illustrated in FIG. 8C, which is suitable for file transfer.

The third exemplary embodiment is a modification of the first exemplary embodiment. However, the present exemplary embodiment can also be a modification of the second exemplary embodiment. If the present exemplary embodiment is applied to the second exemplary embodiment, the display processing unit 23 in FIG. 4 performs the process that “depending on whether a file is a copy-inhibited file, changes the display” in addition to the process that “depending on a transfer mode, generates content information that includes information required in each status and displays the content information”.

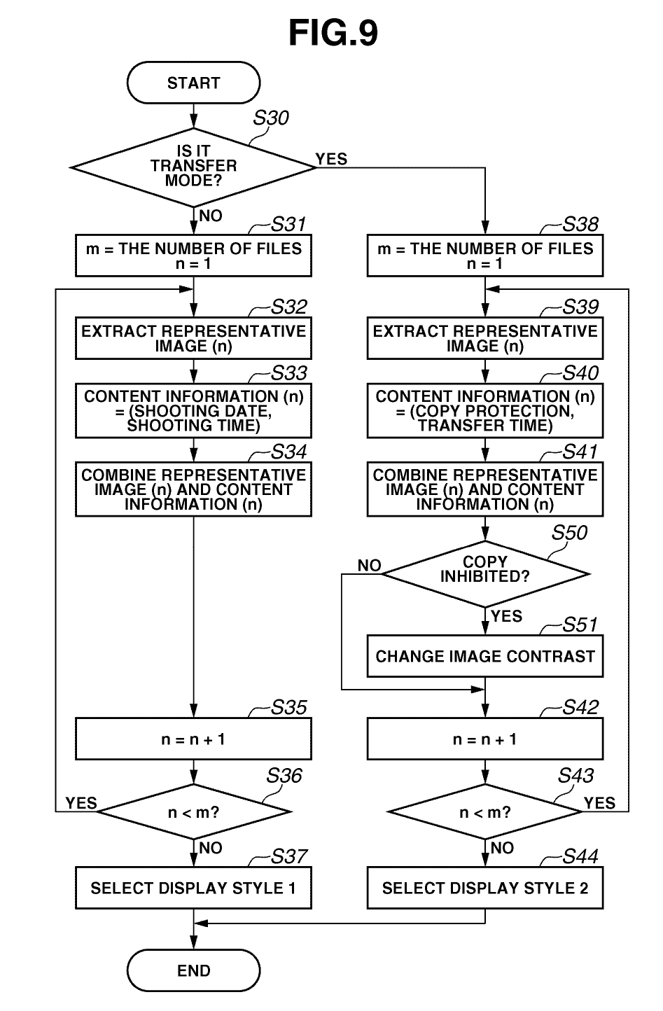

FIG. 9 is a flowchart illustrating an exemplary display process performed by the display processing unit 23 according to the third exemplary embodiment of the present invention. In FIG. 9, the same reference numbers as those in FIG. 5 are applied to steps in which a similar process to that in FIG. 5 according to the second exemplary embodiment is performed, and their descriptions are not repeated. Moreover, in FIG. 9, the same reference numbers as those in FIG. 7 are applied to steps in which a similar process to that in FIG. 7 according to the second exemplary embodiment is performed, and their descriptions are not repeated.

With the process illustrated in FIG. 9, the display processing unit 33 can change the image contrast of a file that is not transferable to an external device, as illustrated in FIG. 8B, to display the file information. Thus, file information adapted for purposes can be displayed in an easily recognizable way, and search performance for files to be transferred can be improved.

### Fourth Exemplary Embodiment

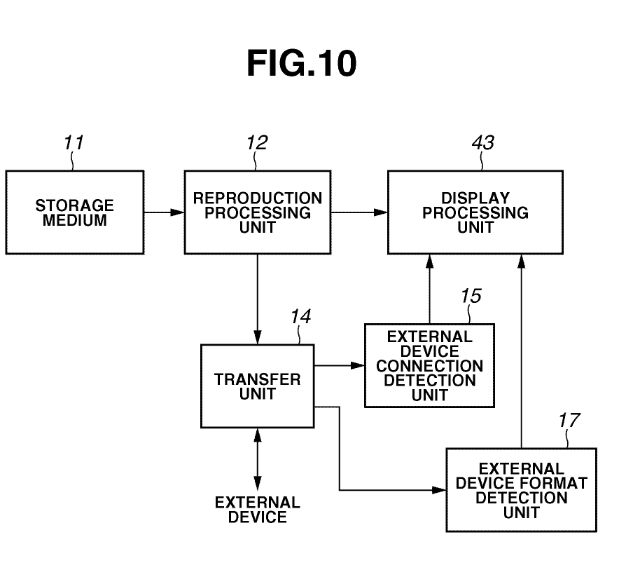

FIG. 10 is a block diagram illustrating essential parts in a hardware configuration of a reproducing apparatus according to a fourth exemplary embodiment of the present invention. The reproducing apparatus illustrated in FIG. 10 includes, in addition to the configuration of the reproducing apparatus according to the first exemplary embodiment, an external device format detection unit 17 as a constituent element. The external device format detection unit 17, for example, detects (acquires) information on a format reproducible (processible) by an external device from the external device via the transfer unit 14.

The reproducing apparatus illustrated in FIG. 10 includes a display processing unit 43 as constituent element instead of the display processing unit 13 according to the first exemplary embodiment. The display processing unit 43 performs control (or process) different from the display processing unit 13.

The display processing unit 43 performs a process that “depending on whether a file is reproducible by an external device, changes the display” in addition to the process that “depending on a status of connection with an external device, generates content information that includes information required in each status and displays the content information” described in the first exemplary embodiment.

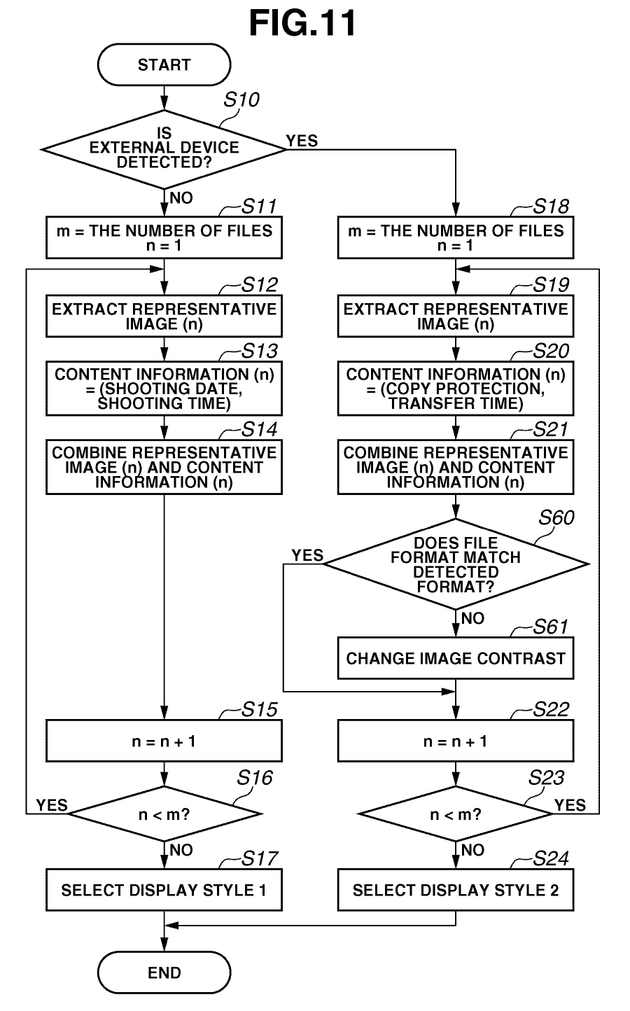

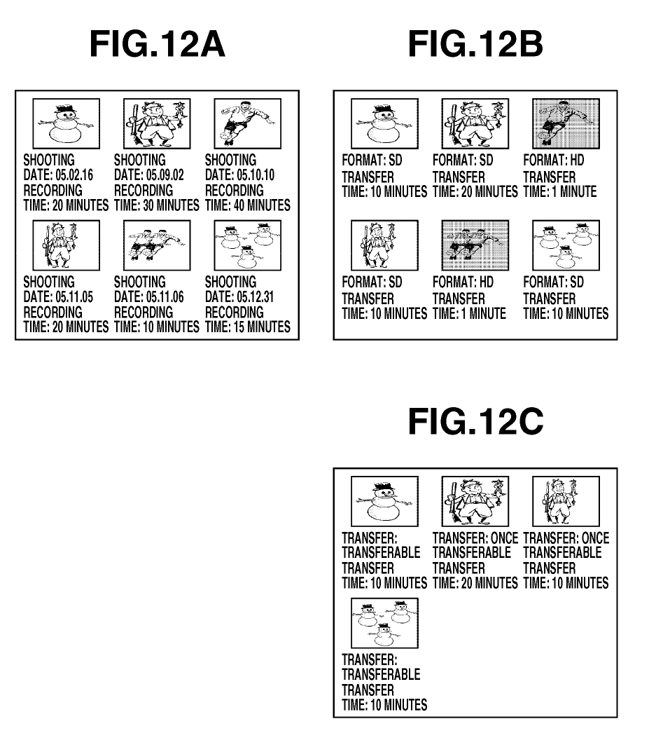

Now, operation of the display processing unit 43 will be described with reference to a flowchart illustrated in FIG. 11 and exemplary displays illustrated in FIGS. 12A to 12C. FIG. 11 is a flowchart illustrating an exemplary display process performed by the display processing unit 43. FIGS. 12A to 12C are views illustrating exemplary displays.

In FIG. 11, the same reference numbers as those in FIG. 2 are applied to steps in which a similar process to that in FIG. 2 according to the first exemplary embodiment is performed, and their descriptions are not repeated. Moreover, a display style illustrated in FIG. 12A is similar to that illustrated in FIG. 3A.

Subsequent to step S21, the process proceeds to step S60. In step S60, the display processing unit 43 determines whether a file format of a file to be processed matches a file format reproducible by an external device detected by the external device format detection unit 17. If the display processing unit 43 determines that the file format of the file to be processed matches the file format reproducible by an external device detected by the external device format detection unit 17 (YES in step S60), the process skips step S61, and proceeds to step S22. On the other hand, if the display processing unit 43 determines that the file format of the file to be processed does not match the file format reproducible by an external device detected by the external device format detection unit 17 (NO in step S60), the process proceeds to step S61. In step S61, the display processing unit 43 changes an image contrast of the image file, for example, by decreasing the image contrast.

In step S24 in FIG. 11, a list is displayed in a display style 2 illustrated in FIG. 12B, which is suitable for file transfer.

With the process illustrated in FIG. 11, the display processing unit 43 can change the image contrast of a file that is not reproducible by an external device, as illustrated in FIG. 12B, to display the file information. Thus, file information adapted for purposes can be displayed in an easily recognizable way, and search performance for files to be transferred can be improved.

It is noted that the process of “image contrast change” in step S61 in FIG. 11 can be changed to the process of “representative image and content information deletion”. In such a case, the list displayed in step S24 in FIG. 11 is displayed in a display style 2 illustrated in FIG. 12C, which is suitable for file transfer.

The fourth exemplary embodiment is a modification of the first exemplary embodiment. However, the present exemplary embodiment can also be a modification of the second exemplary embodiment. If the present exemplary embodiment is applied to the second exemplary embodiment, the display processing unit 23 in FIG. 4 performs the process that “depending on whether a file is reproducible by an external device, changes the display” in addition to the process that “depending on a transfer mode, generates content information that includes information required in each status and displays the content information”.

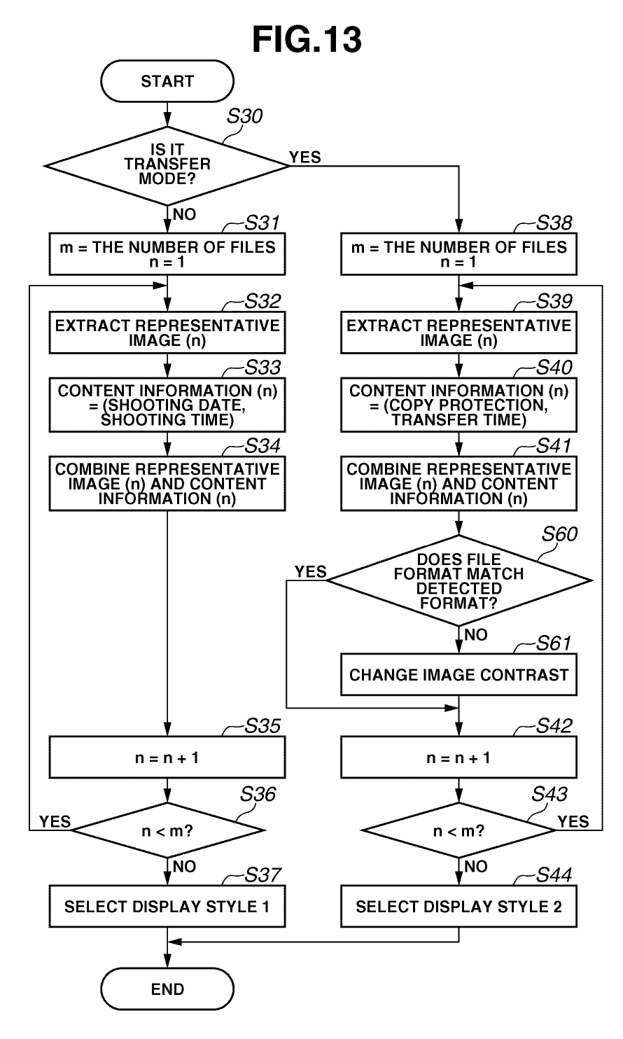

FIG. 13 is a flowchart illustrating an exemplary display process performed by the display processing unit 23. In FIG. 13, the same reference numbers as those in FIG. 5 are applied to steps in which a similar process to that in FIG. 5 according to the second exemplary embodiment is performed, and their descriptions are not repeated. Moreover, the same reference numbers as those in FIG. 11 are applied to steps in which a similar process to that in FIG. 11 is performed, and their descriptions are not repeated.

With the process illustrated in FIG. 13, the display processing unit 23 can change the image contrast of a file that is not reproducible by an external device, as illustrated in FIG. 12B, to display the file information. Thus, file information adapted for purposes can be displayed in an easily recognizable way, and search performance for files to be transferred can be improved.

### Fifth Exemplary Embodiment

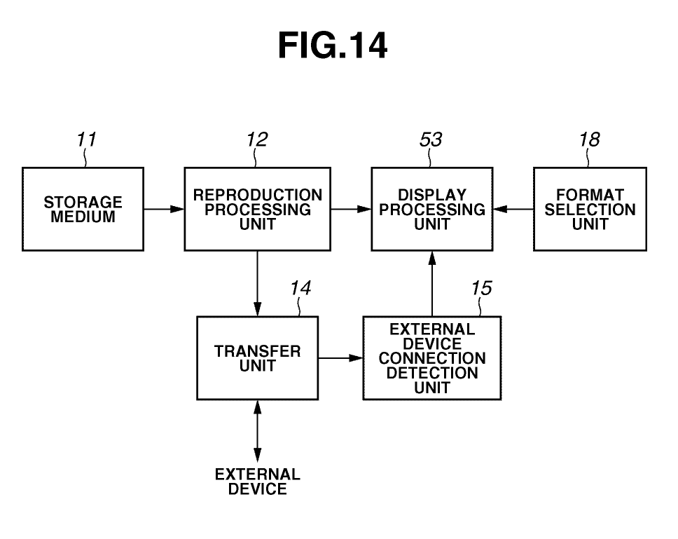

FIG. 14 is a block diagram illustrating essential parts in a hardware configuration of a reproducing apparatus according to a fifth exemplary embodiment of the present invention. The reproducing apparatus illustrated in FIG. 14 includes, in addition to the configuration of the reproducing apparatus according to the first exemplary embodiment, a format selection unit 18 as a constituent element. The format selection unit 18, for example, selects a format (recording format) of a file in response to a user's operation instruction.

The reproducing apparatus illustrated in FIG. 14 includes a display processing unit 53 as a constituent element instead of the display processing unit 13 according to the first exemplary embodiment. The display processing unit 53 performs control (or process) different from the display processing unit 13.

The display processing unit 53 performs a process that “depending on a recording format of a file, changes the display” in addition to the process that “depending on a status of connection with an external device, generates content information that includes information required in each status and displays the content information” described in the first exemplary embodiment.

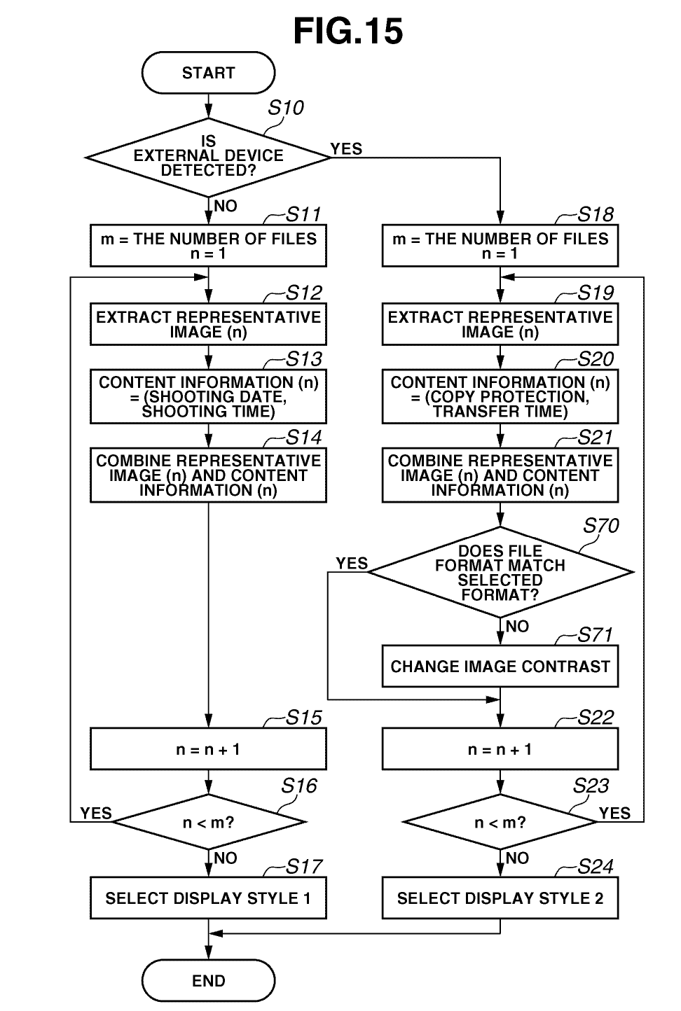

Now, operation of the display processing unit 53 will be described with reference to a flowchart illustrated in FIG. 15 and exemplary displays illustrated in FIGS. 12A to 12C according to the fourth exemplary embodiment. FIG. 15 is a flowchart illustrating an exemplary display process performed by the display processing unit 53.

In FIG. 15, the same reference numbers as those in FIG. 2 are applied to steps in which a similar process to that in FIG. 2 according to the first exemplary embodiment is performed, and their descriptions are not repeated.

Subsequently to step S21, the process proceeds to step S70. In step S70, the display processing unit 53 determines whether a file format of a file to be processed matches a selection file format selected by the format selection unit 18. If the display processing unit 53 determines that the file format of the file to be processed matches the selection file format selected by the format selection unit 18 (YES in step S70), the process skips step S71 and proceeds to step S22. On the other hand, if the display processing unit 53 determines that the file format of the file to be processed does not match the selection file format selected by the format selection unit 18 (NO in step S70), the process proceeds to step S71. In step S71, the display processing unit 53 changes an image contrast of the image file, for example, by decreasing the image contrast.

In step S24 in FIG. 15, a list is displayed in a display style 2 illustrated in FIG. 12B, which is suitable for file transfer.

With the process illustrated in FIG. 15, the display processing unit 53 can change the image contrast of a file of the selection format selected by the format selection unit 18, as illustrated in FIG. 12B, to display the file information. Thus, file information adapted for purposes can be displayed in an easily recognizable way, and search performance for files to be transferred can be improved.

It is noted that the process of “image contrast change” in step S71 in FIG. 15 can be changed to the process of “representative image and content information deletion”. In such a case, the list displayed in step S24 in FIG. 15 is displayed in the display style 2 illustrated in FIG. 12C, which is suitable for file transfer.

The fifth exemplary embodiment is a modification of the first exemplary embodiment. However, the present exemplary embodiment can be a modification of the second exemplary embodiment. If the present exemplary embodiment is applied to the second exemplary embodiment, the display processing unit 23 in FIG. 4 performs the process that “depending on a recording format of a file, changes the display” in addition to the process that “depending on a transfer mode, generates content information that includes information required in each status and displays the content information”.

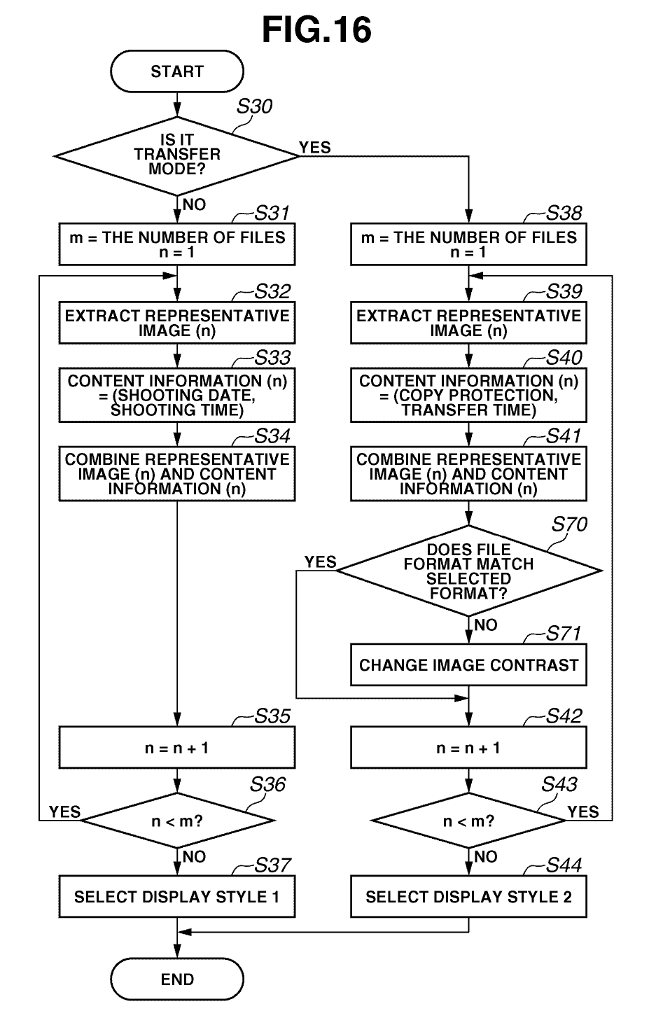

FIG. 16 is a flowchart illustrating an exemplary display process performed by the display processing unit 23. In FIG. 16, the same reference numbers as those in FIG. 5 are applied to steps in which a similar process to that in FIG. 5 according to the second exemplary embodiment is performed, and their descriptions are not repeated. Moreover, the same reference numbers as those in FIG. 15 are applied to steps in which a similar process to that in FIG. 15 is performed, and their descriptions are not repeated.

With the process illustrated in FIG. 16, the display processing unit 23 can change the image contrast of a file of the selection format selected by the format selection unit 18, as illustrated in FIG. 12B, to display the file information. Thus, file information adapted for purposes can be displayed in an easily recognizable way, and search performance for files to be transferred can be improved.

### Other Exemplary Embodiments

In the above-described exemplary embodiments, the descriptions have been made using an example in which each part included in the reproducing apparatuses is configured of hardware. However, an aspect of the present invention can be achieved by providing a storage medium (recording medium) storing software (program) implementing the functions according to the above-described exemplary embodiments to a system or an apparatus, and implementing the software using a computer (a central processing unit or a micro processing unit) in the system or the apparatus. In such a case, the software itself read from the storage medium implements the functions of the above-described exemplary embodiments. Accordingly, the storage medium storing the software constitutes the present invention.

Moreover, in an aspect of the present invention, the functions are realized not only by implementing the software, but by implementing a part or the whole of actual processing using an operating system (OS) or the like running on the computer according to the instructions from the software.

Moreover, in an aspect of the present invention, to realize the above-described functions, the software can be written in a memory of a function enhancing card or a unit connected to a computer. Then, according to instructions from the software, a CPU or the like of the card or the unit can implement a part or the whole of actual processing.

In a case where an aspect of the present invention is applied to a storage medium, software corresponding to the above-described flowcharts is stored in the storage medium.

As described above, according to each exemplary embodiment, file information adapted for purposes can be displayed.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2006-342971 filed on Dec. 20, 2006, which is hereby incorporated by reference herein in its entirety.

What is claimed:

1. A reproducing apparatus comprising:
a reproduction unit configured to reproduce a file recorded on a storage medium;
a transfer unit configured to transfer a file recorded on the storage medium to an external device;
an external device connection detection unit configured to detect a connection with the external device; and
a display processing unit configured to display file information about the file in a first display style if a connection with the external device is detected by the external device connection detection unit and to display file information about the file in a second display style if a connection with the external device is not detected by the external device connection detection unit.

2. The reproducing apparatus according to claim 1, wherein in the first display style, the file information includes information about file transfer, and in the second display style, the file information includes information about file identification.

3. The reproducing apparatus according to claim 2, wherein the information about file transfer includes one of copy protection information, transfer time information, and recording format information.

4. The reproducing apparatus according to claim 2, wherein the information about file identification includes one of shooting date information and recording time information.

5. The reproducing apparatus according to claim 1, wherein in the first display style, among files reproduced by the reproduction unit, file information about a file determined to be transferable is displayed or differentiated and displayed, and wherein in the second display style, file information about all files reproduced by the reproduction unit is displayed.

6. The reproducing apparatus according to claim 1, further comprising a recording format detection unit configured to detect a recording format processible by the external device detected by the external device connection detection unit,
wherein in the first display style, among files reproduced by the reproduction unit, file information about a file of a recording format detected by the recording format detection unit is displayed or differentiated and displayed, and
wherein in the second display style, file information about all files reproduced by the reproduction unit is displayed.

7. The reproducing apparatus according to claim 1, further comprising a recording format selection unit configured to select a recording format,
wherein in the first display style, among files reproduced by the reproduction unit, file information about a file of a selection format selected by the recording format selection unit is displayed or differentiated and displayed, and
wherein in the second display style, file information about all files reproduced by the reproduction unit is displayed.

8. A reproducing apparatus comprising:
a reproduction unit configured to reproduce a file recorded on a storage medium;
a transfer unit configured to transfer a file recorded on the storage medium to an external device;
a mode selection unit configured to select a mode concerning the transfer; and
a display processing unit configured to display file information about the file in a first display style if a mode for transferring a file is selected by the mode selection unit and to display file information about the file in a second display style if the mode for transferring a file is not selected by the mode selection unit.

9. The reproducing apparatus according to claim 8, wherein in the first display style, the file information includes information about file transfer, and in the second display style, the file information includes information about file identification.

10. The reproducing apparatus according to claim 9, wherein the information about file transfer includes one of copy protection information, transfer time information, and recording format information.

11. The reproducing apparatus according to claim 9, wherein the information about file identification includes one of shooting date information and recording time information.

12. The reproducing apparatus according to claim 8, wherein in the first display style, among files reproduced by the reproduction unit, file information about a file determined to be transferable is displayed or differentiated and displayed, and
Wherein in the second display style, file information about all files reproduced by the reproduction unit is displayed.

13. The reproducing apparatus according to claim 8, further comprising a recording format detection unit configured to detect a recording format processible by the external device detected by the external device connection detection unit,
wherein in the first display style, among files reproduced by the reproduction unit, file information about a file of a recording format detected by the recording format detection unit is displayed or differentiated and displayed, and
wherein in the second display style, file information about all files reproduced by the reproduction unit is displayed.

14. The reproducing apparatus according to claim 8, further comprising a recording format selection unit configured to select a recording format,
wherein in the first display style, among files reproduced by the reproduction unit, file information about a file of a selection format selected by the recording format selection unit is displayed or differentiated and displayed, and
wherein in the second display style, file information about all files reproduced by the reproduction unit is displayed.

15. A method for a reproducing apparatus, the method comprising:
reproducing a file recorded on a storage medium;
transferring a file recorded on the storage medium to an external device;
detecting a connection with the external device; and
displaying file information about the file in a first display style if a connection with the external device is detected, and displaying file information about the file in a second display style if a connection with the external device is not detected.

16. A method for a reproducing apparatus, the method comprising:
reproducing a file recorded on a storage medium;
transferring a file recorded on the storage medium to an external device;
selecting a mode concerning the transfer; and
displaying file information about the file in a first display style if a mode for transferring a file is selected, and displaying file information about the file in a second display style if the mode for transferring a file is not selected.
